(19) United States
(12) Patent Application Publication
(10) Pub. No.: US 2008/0055778 A1
(43) Pub. Date: Mar. 6, 2008

(54) Disk Device

(76) Inventor: Yoshikazu Katou, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/661,830

(22) PCT Filed: Sep. 16, 2005
(86) PCT No.: PCT/JP05/17114

§ 371 Date: Mar. 5, 2007

(30) Foreign Application Priority Data
Sep. 17, 2004 (JP) 2004-271079

(51) Int. Cl. G11B 5/60

(52) U.S. Cl. 360/234.5

(57) ABSTRACT

A head IC into which a preamplifier and various sensor amplifiers are integrated allows communications such as register setting to the sensor amplifiers even during reading of the preamplifier. Disk device (100) has head IC (1) into which a read/write preamplifier and various sensor amplifiers are integrated, FPC (21), and disk device control circuit section (31). An operation state of head IC (1) and detection values of the sensor amplifiers are set by setting and reading a register value in amplifier/communication control circuit (9). Read signal differential output lines (25) and (26) or write signal differential input lines (27) and (28) are used as communication lines by switching by change-over switches (7) and (32). Communications are performed in a time-shared asynchronous method with communication control circuit (34) and amplifier/communication control circuit (9), and level of the communication signal is set equal to that of a lead signal or write signal.

### TECHNICAL FIELD

The present invention relates to a disk device such as a magnetic disk device where a head Integrated Circuit (IC) into which a preamplifier and various sensor amplifiers are integrated is mounted on a Flexible Printed Circuit (FPC) for connecting a head actuator side to a disk device control circuit board. Specifically, the present invention relates to a disk device where the communication line is reduced and the disturbance to a reproduced signal caused by a communication signal is eliminated in a head IC for controlling a parameter or operation mode according to setting of a register by serial transfer.

### BACKGROUND ART

Recently, capacity increase and miniaturization of a disk device and increase in data transfer speed have been demanded as information amount and using frequency of a mobile device have been increased in information society. Therefore, the recording density (BPI: Bit Per Inch) of the disk device has been remarkably increased. As the BPI is increased, circuit blocks need to be integrated, the number of interfaces needs to be decreased, and noise occurs in each signal, disadvantageously.

Especially, when a noise is added to a read/write preamplifier circuit having a head IC for amplifying a feeble head read signal, the noise comes into the read data, hence the error rate increases, and the performance decreases.

FIG. 8 is a block diagram of head IC 109 of a conventional disk device and disk device control circuit 110 on a digital circuit side including a micro computer or the like. Especially, FIG. 8 is a block diagram showing a function setting of a read/write preamplifier according to register setting of a serial transfer line. As the functionality of read/write preamplifier circuit 101 as the head IC increases, more registers for setting the function are required. For example, many registers are required for changing the read/sense current in response to use of write current or a Magneto Resistive (MR) head and for setting active mode during access and power save mode during access wait.

A conventional art is disclosed in Japanese Patent Unexamined Publication No. H11-3502. In this example, as shown in FIG. 8, register 102 is built in a read/write preamplifier circuit, setting and reading of a register by serial transfer respond to increase in functionality, and various set circuit constants and circuit states can be read. The serial transfer line is generally formed of three lines:
transfer line 103 for transmitting serial data enable signal SDEN;
transfer line 104 for supplying serial transfer clock SCLK; and
transfer line 105 for transmitting register set data SDATA.
   The signal levels thereof depend on the level of a Complementary Metal Oxide Semiconductor (CMOS) logic or Transistor-Transistor Logic (TTL) that operates at 0-3.3 V or 0-5 V.

FIG. 9 is a timing chart for register setting by the serial transfer line of FIG. 8. In FIG. 9, serial data enable signal SDEN is a high enable signal. Usually, data is set into register 102, or is read from it at an enabling time. Serial transfer clock SCLK is a clock for data setting. In this example, the data setting is performed at a rising edge, namely a positive edge. Serial transfer data SDATA is determined by rising of serial transfer clock SCLK, and defines transfer data to register 102.

In the conventional example, a high impedance circuit is disposed on the side of the digital circuit 101 such as a microcomputer for setting the register of head IC 101. The high impedance circuit sets the serial transfer line to have high impedance (Hi-Z) except in register setting. It is proposed that, by setting the serial transfer line to have the high impedance except in data setting, the signal line is divided elastically insulatedly into the digital circuit side including the microcomputer and the head IC side to prevent the noise on the digital circuit side from affecting the head IC. Here, the serial transfer line is used for register setting of the head IC that functions as the read/write preamplifier circuit.

Recently, as mobile devices have become widespread, disk devices have been further miniaturized. In these disk devices, a plurality of circuit blocks having different functions are integrated into one IC, which is the so-called system-on-chip. In the future, a read/write preamplifier is also integrated with various sensor amplifiers into one IC. When a head IC for a single function of the conventional read/write preamplifier is used, the read/write operation and communication operation can be separated from each other in time. When other sensor amplifier is also integrated with the read/write preamplifier, however, the communication with the sensor amplifier is asynchronous to the read/write operation, and hence the serial operation is required also during read operation. As the latter sensor amplifier to be integrated, a temperature sensor amplifier to be generally mounted in the disk device can be used, for example. As the temperature sensor amplifier, a thermo-couple of which resistance is varied with temperature, or an amplifier for detecting and amplifying voltage Vbe between the base and emitter in a transistor of which voltage varies is used, for example. The amplified voltage is analog/digital(A/D)-converted, and stored in a register, and the contents in the register are read by the microcomputer or the like, thereby allowing a user to know the temperature of the disk device. As the density of the disk device increases, the microcomputer is required to finely adjust the equalizing characteristic of a read signal in response to the temperature. It has recently become important to always monitor the temperature of the disk device.

While the serial transfer line is set to have Hi-Z high impedance in the conventional configuration, however, setting or reading from the register cannot be performed. Further, communications with the head IC require three communication lines. Many pins of the connector for connecting the head IC to the side of a digital circuit such as the microcomputer are consumed, so that it becomes difficult to miniaturize the disk device.

### SUMMARY OF THE INVENTION

The present invention addresses conventional problems in a head IC into which a read/write preamplifier and various sensor amplifiers are integrated. Even during read operation of the read/write preamplifier, register setting or the like can be transmitted to the various sensor amplifiers. The present invention provides a disk device that does not require the communication lines conventionally required for communications and can continuously perform a sufficient read operation while preventing the communication signal from disturbing read signals.

In the disk device of the present invention, an actuator for moving a head in the direction crossing tracks of a disk medium is electrically connected through an FPC to a digital control circuit board including a microcomputer or the like disposed in the device case. The head IC into which the read/write preamplifier and various sensor amplifiers are integrated is mounted and connected to the FPC. The operation state of the head IC can be varied according to the value of a register included in it. Each of values detected by the head IC is stored in the register. The reading is allowed by communications from the digital control circuit side. For the communications, one of the input line of a write signal and the output line of a read signal, or both of them are used.

The input line of the write signal and the output line of the read signal are of differential two-wire types, respectively, and are paired with each other. The signal level is set the same as that of the read signal or write signal in communications.

### BRIEF DESCRIPTION OF DRAWINGS

FIG. 1 is a block diagram of a disk device in accordance with exemplary embodiment 1 of the present invention.

FIG. 2A is a detailed block diagram of a communication control circuit in accordance with exemplary embodiment 1.

FIG. 2B is a detailed block diagram of an amplifier/communication control circuit in accordance with exemplary embodiment 1.

FIG. 3 is a timing chart illustrating a communication method in accordance with exemplary embodiment 1.

FIG. 4 is a block diagram of a disk device in accordance with exemplary embodiment 2 of the present invention.

FIG. 5 is a timing chart illustrating a communication method in accordance with exemplary embodiment 2.

FIG. 6 is a timing chart illustrating setting into a head IC in the communication method in accordance with exemplary embodiment 2.

FIG. 7 is a timing chart illustrating reading from the head IC in the communication method in accordance with exemplary embodiment 2.

FIG. 8 is a block diagram of a conventional disk device.

FIG. 9 is a timing chart illustrating a conventional communication method.

### REFERENCE MARKS IN THE DRAWINGS

1 head IC
3 read amplifier
6 write amplifier
7, 32 change-over switches
8, 33 bidirectional buffers
9, 74 amplifier/communication control circuits
10, 35 oscillators (OSCs)
15 temperature sensor
16 temperature sensor amplifier
17, 20 A/D converters
18 shock sensor
19 shock sensor amplifier
21 Flexible Printed Circuit (FPC)
22 positive power supply signal line
23 negative power supply signal line
24 ground signal line
25, 26 read signal differential output lines
27, 28 write signal differential input lines
29 read/write signal line
30 fault signal line
31 disk device control circuit section
34, 75 communication control circuits.
36 system controller
70 enable signal line
100 disk device

### DETAILED DESCRIPTION OF PREFERRED EMBODIMENTS

Exemplary embodiments of the present invention will be described hereinafter with reference to the drawings.

### First Exemplary Embodiment

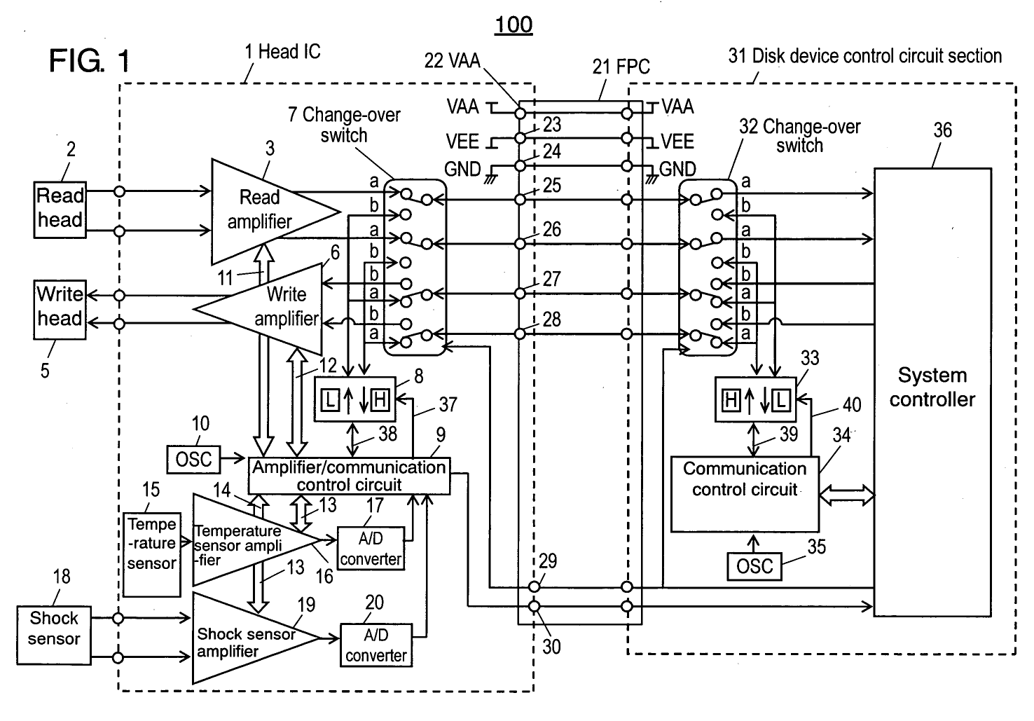

FIG. 1 is a block diagram of a disk device in accordance with exemplary embodiment 1 of the present invention. Disk device 100 has head IC 1 and disk device control circuit section 31. Head IC 1 is coupled to disk device control circuit section 31 through FPC 21. Disk device 100 further has read head 2, write head 5, and shock sensor 18.

Integrated read amplifier 3 and write amplifier 6 are mounted on head IC 1. Head IC 1 further has change-over switch 7, bidirectional buffer 8, and amplifier/communication control circuit 9. Head IC 1 further has OSC 10, temperature sensor 15, temperature sensor amplifier 16, and A/D converters 17 and 20.

Various input/output terminals are also prepared in head IC 1. Head IC 1 is mounted and coupled to FPC 21 described later, and transmits and receives signals from disk device control circuit section 31 via FPC 21.

Disk device control circuit section 31 has change-over switch 32, bidirectional buffer 33, communication control circuit 34, OSC 35, and system controller 36. A read channel, microcomputer, hard disk controller, servo controller, and memory that are not shown are mounted on system controller 36. Various input/output terminals are disposed in disk device control circuit section 31. These input/output terminals are prepared for transmitting and receiving signals from head IC 1 via FPC 21.

Head IC 1 is electrically coupled to disk device control circuit section 31 via various signal lines 22 through 30 arranged on FPC 21. Positive power supply (hereinafter referred to as “VAA”) signal line 22, negative power supply (hereinafter referred to as “VEE”) signal line 23, and ground (hereinafter referred to as “GND”) signal line 24 are prepared for supplying power to head IC 1. Read signal differential output lines 25 and 26, write signal differential input lines 27 and 28, read/write signal line 29, and fault signal line 30 are also arranged.

Read head 2 and write head 5 arranged on the head IC 1 side sense signals recorded on a disk (not shown), and record data on the disk. Read amplifier 3 and write amplifier 6 are integrated and mounted in head IC 1. A differential output of a read signal supplied from read amplifier 3 is output via read signal differential output lines 25 and 26. A differential output of a write signal is fed into write amplifier 6 via write signal differential output(input ?) lines 27 and 28.

Change-over switches 7 and 32 and bidirectional buffers 8 and 33 are configured so as to operate in interlock with each other. The change-over switches and bidirectional buffers are configured so that a signal travels on the H side when control lines 37 and 40 lie at High level or travels on the L side when they lie at Low level.

Oscillators 10 and 35 oscillate at a predetermined frequency. Oscillator 10 generates a signal for driving amplifier/communication control circuit 9. Oscillator 35 generates a signal for driving communication control circuit 34.

Amplifier/communication control circuit 9 controls read amplifier 3, write amplifier 6, temperature sensor amplifier 16, and shock sensor amplifier 19. Amplifier/communication control circuit 9 controls bidirectional buffer 8 via control line 37, and also controls the communications with disk device control circuit section 31.

Communication control circuit 34 controls communications with head IC 1. Temperature sensor 15 detects temperature of head IC 1, and outputs a predetermined voltage responsive to the temperature. Temperature sensor amplifier 16 amplifies a relatively small output voltage supplied from temperature sensor 15 to a value high enough to drive A/D converter 17. A/D converter 17 converts the analog voltage amplified by temperature sensor amplifier 16 into a digital signal.

Shock sensor 18 detects a shock gotten by disk device 100. Shock sensor amplifier 19 amplifies a relatively small analog voltage occurring in shock sensor 18 to a predetermined value. AID converter 20 converts the analog voltage supplied from shock sensor amplifier 19 into a digital signal. Amplifier/communication control circuit 9 is controlled with the converted digital signal.

Next, an operation of each section is described hereinafter. Read head 2, read amplifier 3, write head 5, and write amplifier 6 are mounted in the conventional head IC, and have a known configuration, so that detailed descriptions of them are omitted. Read amplifier 3 and write amplifier 6 receive a set value of a register mounted on amplifier/communication control circuit 9 via control bus lines 11 and 12, and adjusts the amplifier gain, band, bias current, and write current in response to the set value.

Read amplifier 3 and write amplifier 6 supply, to amplifier/communication control circuit 9, error information showing whether or not operations of read head 2 and write head 5 are normal, and store it in a predetermined area of the register. The error information is directly supplied to disk device control circuit section 31 via fault signal line 30. An output format of the error information is selected in response to the setting of the register.

An example of relation between the set value of the register and each circuit is described hereinafter. When a register for eight-bits of data is assigned to an eight-bit address, for example, a register region capable of storing total of 2048-bits of data can be defined. Generally, so large number of bits are not required, and only an appropriate address region can be used. As an example, a process of setting write current of the write amplifier using eight bits at the zeroth address is described hereinafter. The number of data bits is eight, so that 256 different current values can be defined. However, the current amplitude value from 10 mApp to 73.75 mApp is made to respond to it. In other words, whenever data increases by one, the amplitude at a write current value of 0.25 mA increases. Therefore, when the amplitude value of the write current is set at 50 mApp, an eight-bit register is recommended to be set for “10100000” corresponding to 160. This set value is supplied to write amplifier 6 via above-mentioned control bus 12, and write current variable circuit disposed in the write amplifier adjusts the write current.

An operation and a communication method of amplifier/communication control circuit 9 and communication control circuit 34, which are main parts of the present invention, are described hereinafter. A signal for switching between read and write is supplied to R/W signal line 29. This switching signal is controlled based on a command of system controller 36. When the signal of R/W signal line 29 lies at High level, the state is set at read. When the signal lies at Low level, the state is set at write. When the signal of R/W signal line 29 lies at High level, change-over switch 7 is coupled to the contact (a) side via control line 38 by amplifier/communication control circuit 9.

Similarly, change-over switch 32 is coupled to the contact (a) side via control line 39 by communication control circuit 34. When the signal of R/W signal line 29 lies at Low level, both change-over switch 7 and change-over switch 32 are coupled to the contact (b) side. Therefore, bidirectional buffers 8 and 33 are coupled to two write signal differential input lines 27 and 28 of the write signal in the read state. In the write state, bidirectional buffers 8 and 33 are coupled to read signal differential output lines 25 and 26. Just after power-on of the disk device, communication control circuit 34 is initialized on the transmission side, and amplifier/communication control circuit 9 is initialized on the reception side.

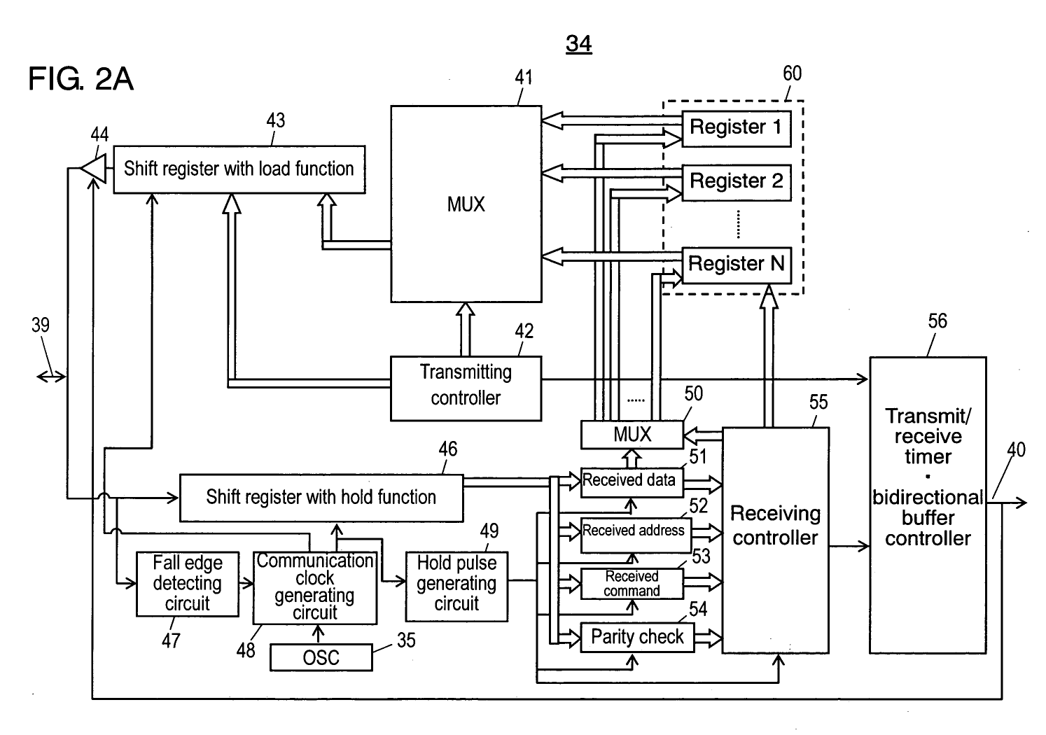

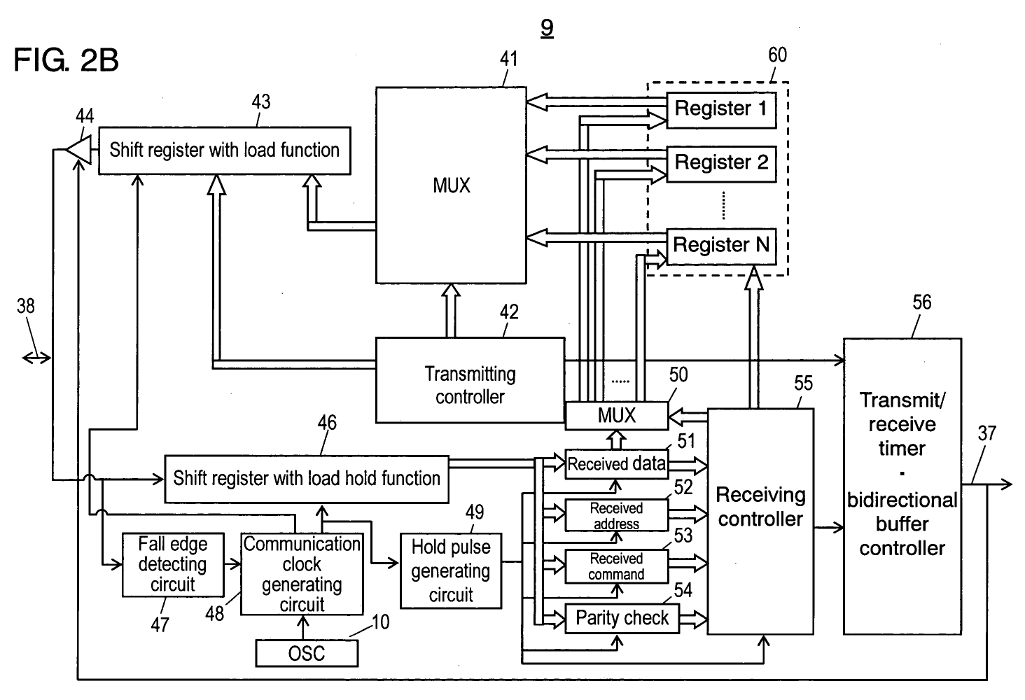

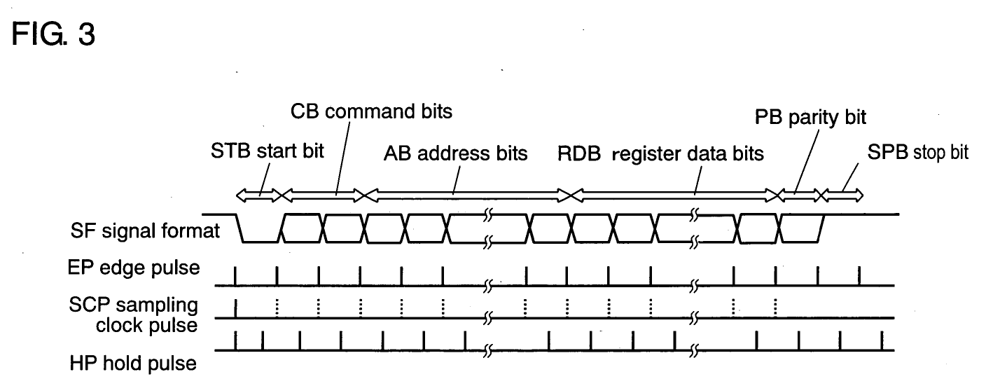

A detailed operation of amplifier/communication control circuit 9 and communication control circuit 34 is described hereinafter with reference to the block diagrams of FIG. 2A and FIG. 2B and the timing chart of FIG. 3. FIG. 2A is a block diagram of an internal configuration of communication control circuit 34 shown in FIG. 1. FIG. 2B is a block diagram of an internal configuration of amplifier/communication control circuit 9, similarly. In FIG. 2A and FIG. 2B, the same reference marks have the same functions.

Each of communication control circuit 34 of FIG. 2A and amplifier/communication control circuit 9 of FIG. 2B has the following elements:
register group 60 having register 1 through register N for storing data used for communications;
multiplexer (MUX) 41 for selecting and outputting the value of each register of register group 60;
transmitting controller 42 for controlling the transmission; and
shift register 43 with a load function for converting transmitted data into serial data.
   Each of communication control circuit 34 and amplifier/communication control circuit 9 further has buffer 44 with an output enable function of controlling the output of the shift register with the load function.

Control line 39 of FIG. 2A is similar to control line 39 of FIG. 1, and is connected to bidirectional buffer 33. Communication control circuit 34 and amplifier/communication control circuit 9 further have the following elements:
shift register 46 for converting serial data to parallel data;
fall edge detecting circuit 47 for detecting a fall edge of received data;
communication clock generating circuit 48 for generating a communication clock from a basic clock; and
hold pulse generating circuit 49 for generating a pulse for holding data of shift register 46.
   OSC 35 is an oscillating circuit for generating a basic pulse for driving communication clock generating circuit 48.

Communication control circuit 34 and amplifier/communication control circuit 9 further have the following elements:
received data register 51;
received address register 52;
received command register 53; and
parity check register 54.

Communication control circuit 34 and amplifier/communication control circuit 9 further have receiving controller 55 and transmit/receive timer/bidirectional buffer controller 56. Receiving controller 55 performs receiving processing in response to the received contents. Transmit/receive timer/bidirectional buffer controller 56 counts a predetermined time based on commands from transmitting controller 42 and receiving controller 55, and controls bidirectional buffer 33 in response to the count state. Thus, bidirectional buffer 33 is controlled via control line 40.

Transmit/receive timer/bidirectional buffer controller 56 shown in FIG. 2A controls bidirectional buffer 33 via control line 40. Transmit/receive timer/bidirectional buffer controller 56 shown in FIG. 2B controls bidirectional buffer 8 via control line 37.

Control lines 39 and 40 of FIG. 2A and control lines 37 and 38 of FIG. 2B are the same as those of FIG. 1.

FIG. 3 shows a signal format used for communications. This signal format is obtained by expanding Universal Asynchronous Receiver Transmitter (UART) of an asynchronous communication type used for RS232C communications. The RS232C has one start bit STB, eight-bits of data length, zero parity bit PB, and one stop bit SPB, and separates lines on the transmission side from lines on the reception side.

In embodiment 1, the number of start bits STB is one, and 18 bits of data length is divided into two command bits CB, eight address bits AB, and eight register data bits RDB. The number of parity bits PB is one, and the number of stop bits SPB is one. Two command bits CB define setting request command (00), receiving request command (01), request OK command (10), and request NG command (11). Start bit STB is always set at Low level, and stop bit SPB is always set at High level. Parity bit PB is exclusive OR of all bits, and can collate received data.

Next, a process of setting a predetermined value in a register in head IC 1 is described with reference to FIG. 1, FIG. 2A, FIG. 2B, and FIG. 3. In communication control circuit 34, firstly, system controller 36 previously stores a set value in register group 60, and indicates the address number of the set register to transmitting controller 42 (not shown). Here, as the set value, eight-bits of data of “10100000” corresponding to 160 is set at the zeroth address when the above-mentioned write current value is set at 50 mApp. Based on the indication, transmitting controller 42 controls MUX 41, and makes shift register 43 with a load function to load a predetermined register value. The setting request command, address, control bits (start bit STB, stop bit SPB, and parity bit PB) are simultaneously loaded. Transmitting controller 42 shifts data of shift register 43 with the load function every transmission clock fed from the communication clock generating circuit, and outputs it via buffer 44 and input/output line 39 so that it has the same bit string as that of signal format SF shown in FIG. 3.

Transmitting controller 42 outputs all bit strings, and then starts a timer that has been set at a time long enough to receive the received data in transmit/receive timer/bidirectional buffer controller 56. Transmit/receive timer/bidirectional buffer controller 56, during working of the timer, switches bidirectional buffer 33 to the receiving state on L side via control line 40, and disables the output of buffer 44. In amplifier/communication control circuit 9, fall edge detecting circuit 47 detects fall of the start bit of the input received data, and generates edge pulse EP. Communication clock generating circuit 48 resets a counter for counting the bit cycle of internal communication data with edge pulse EP, and decodes a predetermined value, thereby generating sampling clock pulse SCP. A sample rate of sampling clock pulse SCP is generally called a bow rate.

Even when oscillating frequency of OSC 10 is shifted from that of OSC 35, a stable region in the received data can be sampled. The input received data is fed into shift register 46, and sequentially shifted with sampling clock pulse SCP. Hold pulse generating circuit 49 generates hold pulse HP indicating timing of data holding based on detection of fall edge pulse EP, sampling clock pulse SCP, and start bit STP. Based on hold pulse HP, received data register 51 stores register data bits RDB, received address register 52 stores address bits AB, received command register 53 stores command bits CB, and parity register 54 stores parity bit PB.

Receiving controller 55 calculates exclusive OR of respective bits in registers 51 through 53, checks the result against the parity bit, and recognizes the reliability of the received data. When no error is found in this check, the received data is stored in the register at the received address of register group 60. Then, in transmit/receive timer/bidirectional buffer controller 56, the timer that has been set at a time long enough to transmit transmitted data is started. During working of the timer, transmit/receive timer/bidirectional buffer controller 56 switches bidirectional buffer 8 to the transmitting state via control line 37, and enables the output of buffer 44.

Receiving controller 55 issues a command to the transmitting controller, and transmits a bit string to communication control circuit 34. Here, the bit string includes a request OK command in addition to the received data and address when no error is found in the check, or includes a request NG command in addition to the received data and address when an error is found. The transmitted data is received by communication control circuit 34 using the same receiving procedure as that discussed above, and is checked against the previously transmitted data. When no error is found, the transmitting/receiving processing is completed. When the request NG command is received, or an error is found in the check against the previously transmitted data, however, the transmitting/receiving processing is repeated.

Next, a process of reading a value of a register disposed in head IC 1 is described.

In communication control circuit 34, firstly, system controller 36 indicates the address number of the register to be read from head IC 1 to transmitting controller 42 (not shown). Based on the indication, transmitting controller 42 loads a receiving request command, address, data, and control bits to shift register 43 with the load function. Here, all of register data bits RDB are set at zero. Transmitting controller 42 shifts data of shift register 43 with the load function every transmission clock fed from the communication clock generating circuit, and outputs serial data from buffer 44 so that it has the same bit string as that of signal format SF shown in FIG. 3.

Transmitting controller 42 outputs all bit strings, and then starts the timer that has been set at a time long enough to receive the received data in transmit/receive timer/bidirectional buffer controller 56. Transmit/receive timer/bidirectional buffer controller 56, during working of the timer, switches bidirectional buffer 33 to the receiving state via control line 40, and disables the output of buffer 44. In amplifier/communication control circuit 9, of the bit string received as discussed above, received data register 51 stores register data bits RDB, received address register 52 stores address bits AB, received command register 53 stores command bits CB, and the parity register stores parity bit PB.

Receiving controller 55 calculates exclusive OR of respective bits in registers 51 through 53, checks the result against the parity bit, and recognizes the reliability of the received data. When any error is not found in this check, receiving controller 55 commands transmitting controller 42 to transmit the register at the received address of register group 60. Simultaneously, receiving controller 55 starts the timer that has been set at a time long enough to transmit transmitted data in transmit/receive timer/bidirectional buffer controller 56. During working of the timer, transmit/receive timer/bidirectional buffer controller 56 switches bidirectional buffer 8 to the transmitting state via control line 37, and enables the output of buffer 44. Transmitting controller 42 receives the command from receiving controller 55. When no error is found in the check, transmitting controller 42 transmits, to communication control circuit 34, a bit string where the request OK command, address, and control bits are added to the register value at the received address of the register group 60. When an error is found in the check, transmitting controller 42 sets all of the data bits in the register group, and transmits, to communication control circuit 34, a bit string where the request NG command, address, and control bits are added to the register value. The transmitted data is received by communication control circuit 34 using the same receiving procedure as that discussed above. Communication control circuit 34 checks the parity bit, and checks the transmitted data against the request address of the previously transmitted data. When no error is found, the transmitting/receiving processing is completed. When the request NG command is received, or an error is found in the check, however, the transmitting/receiving processing is repeated.

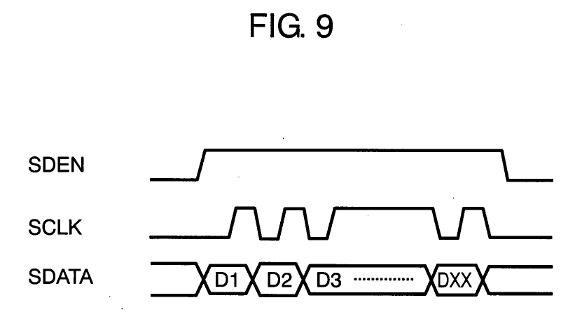

The above-mentioned communication means does not require three lines, namely serial communication lines for SDATA, SCLK, and SDEN (refer to FIG. 9), that are conventionally required, and can reduce the number of pins in the FPC for coupling the head IC to the digital control circuit side. As a result, the mounting area of the connector (FPC) on the circuit board to be mounted to the case of the disk device can be reduced, and the disk device can be further miniaturized.

The transmitting/receiving processing circuit is formed of a digital signal processing circuit as discussed above, but is also formed of a processing circuit employing a logic cell for IC driven at low power supply voltage of about 0.5 V-1.5 V, and considers noise leakage into the read signal in a read amplifier circuit. The write signal and read signal lie at a signal level of LVDS (Low Voltage Differential Small-Computer-System-Interface (SCSI)) standard “TIA/EIA-644” of about 300 mVpp on one side, so that cells for IC similar to an LVDS driver and receiver used for the interface of the write signal are used for communication interface.

Thanks to this configuration, the cross talk component can be made smaller by 1.5 dB or more than that in conventional serial communications at the CMOS or TTL signal level of 3.3 V or 5.0 V. Paired wiring of a differential two-wire type is employed, so that noise of a high-frequency component occurring during communications is reduced by capacity coupling between differentials, and influence on the power supply ground can be reduced. Therefore, even when head IC 1 lies in the read state, a problem that signal noise due to communications disturbs the read signal can be prevented. A disk device capable of obtaining a sufficient read signal while setting and reading a register of head IC 1 can be provided.

In embodiment 1, a method of using both a read signal output line and a write signal input line as communication lines has been described. However, even when only one of them is used for reducing the gate scale of the IC and the number of kinds of the sensor amplifiers integrated with a write/read preamplifier circuit, there is no problem. For example, the device temperature detected by a temperature sensor is not a parameter that increases and decreases in a very short time, and hence is not required to be monitored in write operation performed in a relatively short time. Therefore, communications are not required during writing, and hence only the write signal input line is required to be used also as a communication line.

In embodiment 1, the switch between the bidirectional buffers is asynchronous, so that the switch timing shifts and both write and read signals are output disadvantageously. However, pull-up resistance is connected to a midway of the line using an open-collector form for a circuit used for output, and a transistor of the open-collector is designed to be OFF state because the signal level lies at High level even when both write and read states are output states.

### Second Exemplary Embodiment

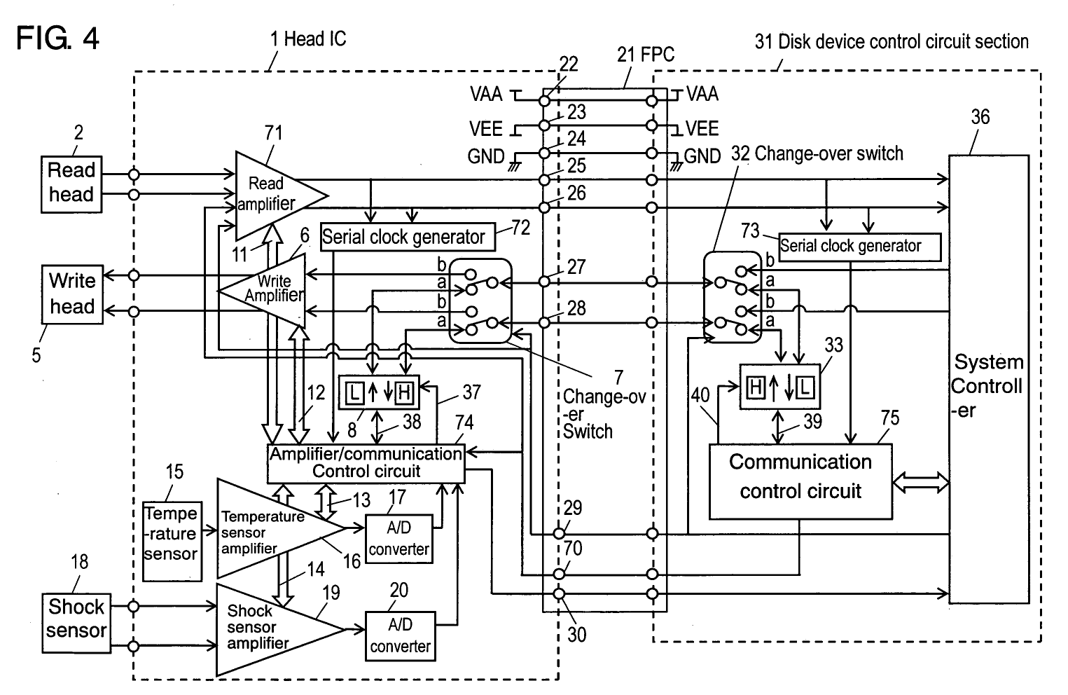

FIG. 4 is a block diagram of a disk device in accordance with exemplary embodiment 2 of the present invention. Main elements in FIG. 4 are described hereinafter, but the elements having the same function as that in FIG. 1 are denoted with the same reference marks. In FIG. 4, head IC 1 has read amplifier 71, serial clock generator 72, and amplifier/communication control circuit 74. Read amplifier 71 has a built-in oscillator (not shown). Serial clock generators 72 and 73 make an output signal from read amplifier 71 pass a predetermined filter, and generate a serial clock for communications with a comparator. Amplifier/communication control circuit 74 has a function substantially similar to that of amplifier/communication control circuit 9, and controls register setting of each amplifier and the communications. Amplifier/communication control circuit 74 of exemplary embodiment 2 employs a communication method different from that of exemplary embodiment 1, and hence is denoted with a different reference mark.

Disk device control circuit section 31 has serial clock generator 73 and communication control circuit 75. Communication control circuit 75 has a function substantially similar to that of communication control circuit 34 of FIG. 1, but employs a communication method different from that thereof, and hence is denoted with a different reference mark. The disk device of embodiment 2 differs from that of embodiment 1 (FIG. 1) in that enable signal line 70 is disposed for extracting an enable signal from communication data supplied from communication control circuit 75 in embodiment 2.

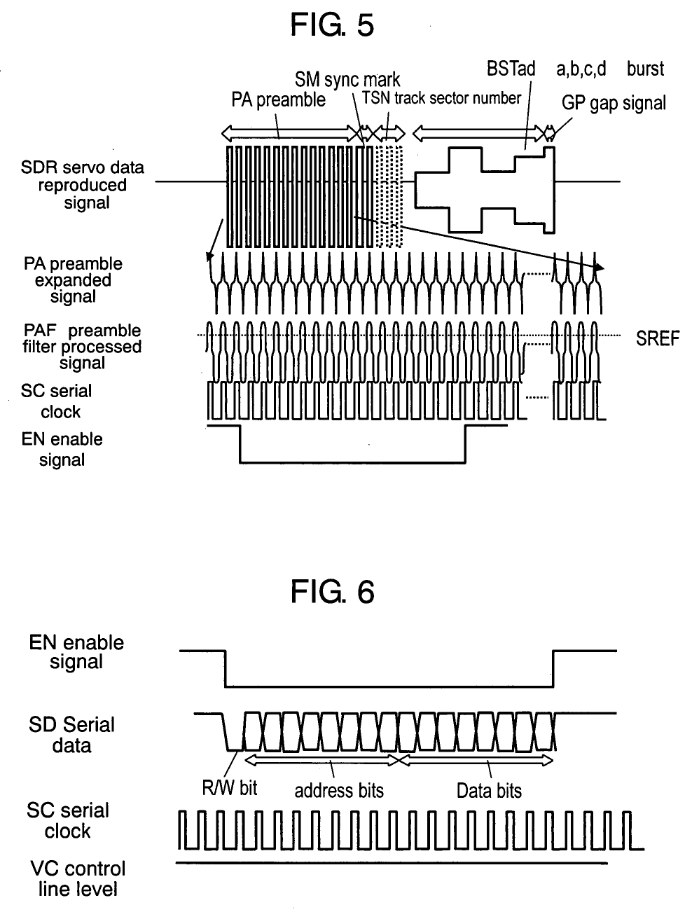

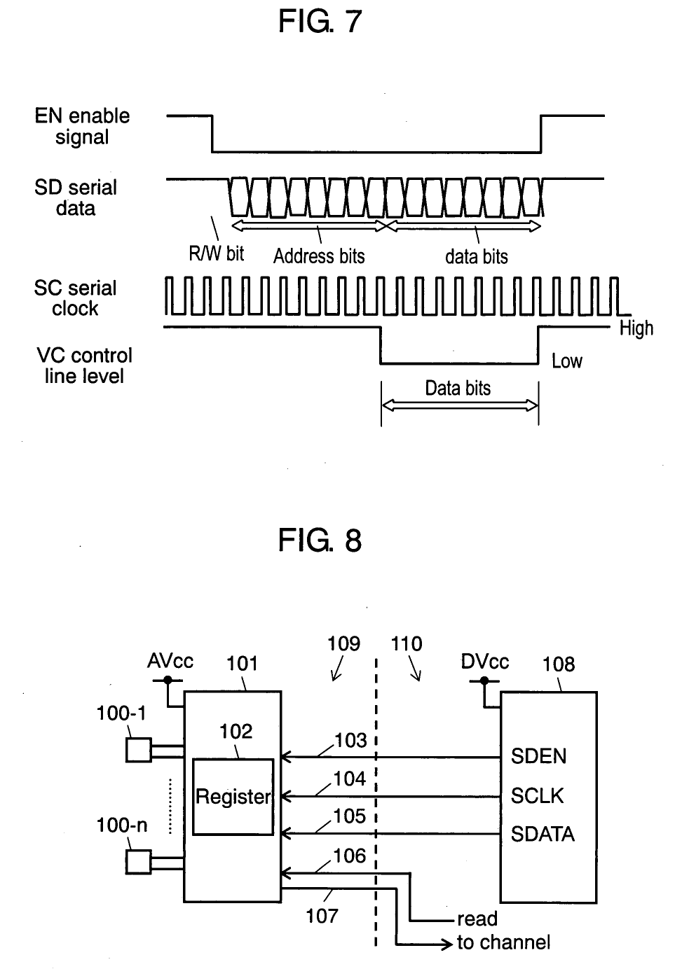

An operation of the disk device of embodiment 2 shown in FIG. 4 is described hereinafter with reference to the timing charts of FIG. 5, FIG. 6 and FIG. 7.

FIG. 5 shows reproduced signal SDR of servo data recorded in a recording medium such as a hard disk in the disk device. In FIG. 5, reproduced signal SDR of the servo data is formed of data including preamble PA, sync mark SM, track/sector number TSN, a,b,c,d burst BSTad, and gap signal GP. The function of each signal is known and hence is not described. Rectangular wave of single frequency is recorded in preamble PA, and is used for locking Phase Locked Loop (PLL) and Automatic Gain Control (AGC). Sync mark SM is used for synchronizing the cycles of the servo data and signal processing. In track/sector number TSN, a gray-coded address number is generally assigned to each servo data. A,b,c,d burst BSTad represents relative positional information of a servo, and gap signal GP is prepared for absorbing rotation jitter in recording user data.

In FIG. 5, the downside of reproduced signal SDR shows the waveform obtained by expanding preamble PA, and this waveform is a reproduced waveform of the recorded signal of a constant frequency.

When preamble PA is fed into serial clock generators 72 and 73 shown in FIG. 4, preamble PA undergoes a predetermined filter processing and is shaped into expanded signal PAF of preamble PA. The filter characteristic required for the filter processing is not especially described, but is required to compensate a frequency component that is lost in a recording/reproducing system in a recording medium. For example, regarding magnetic recording, a low-pass compensation filter used for integral detection or a matched filter is considered.

Serial clock generators 72 and 73 of FIG. 4 compare signal waveform PAF shown in FIG. 5 with predetermined level SREF, perform waveform shaping, and then generate and output serial clocks SC. Serial clock SC supplied from serial clock generator 72 of FIG. 4 is fed into amplifier/communication control circuit 74, and serial clock SC supplied from serial clock generator 73 is fed into communication control circuit 75. Communication control circuit 75 previously receives a servo gate signal indicating timings of the beginning and end of the servo data from system controller 36. Communication control circuit 75 generates enable signal ES of FIG. 5 from serial clock SC and the servo gate signal, and outputs it.

FIG. 6 shows a communication format in setting a register from communication control circuit 75 to amplifier/communication control circuit 74. The signal shown in the highest stage in FIG. 6 corresponds to enable signal ES of FIG. 5.

Communication control circuit 75 outputs serial data SD of FIG. 6 coincidently with enable signal ES and serial clock SC. Serial data SD is transmitted to amplifier/communication control circuit 74 through line 39, bidirectional buffer 33, change-over switch 32, write signal differential input lines 27 and 28, change-over switch 7, bidirectional buffer 8, and line 38.

Serial clock SC shown in FIG. 6 corresponds to serial clock SC shown in FIG. 5. In FIG. 6, control line level VC shows the level state of control lines 37 and 40. When control line level VC is High level, both bidirectional buffers 8 and 33 are installed along the signal flow on H side. The first bit of serial data SD shows an R/W bit, next eight bits show an address of the register, and eight bits after next show data in the register lying at this address. When the R/W bit lies at Low level, the register is written from communication control circuit 75 to amplifier/communication control circuit 74. When the R/W bit lies at High level, the register is read from amplifier/communication control circuit 74 to communication control circuit 75. In FIG. 6, the R/W bit lies at Low level, so that the value in data bits is set in the register at the address corresponding to the address bits.

FIG. 7 shows the same signal as that in FIG. 6, the R/W bit lies at High level. Control lines 37 and 40 lie at Low level for the duration of data bits, bidirectional buffers 8 and 33 are placed on L side for the duration, amplifier/communication control circuit 74 becomes the transmitting side, and communication control circuit 75 becomes the receiving side. At this time, amplifier/communication control circuit 74 transmits the value of the register at the address indicated by communication control circuit 75.

In embodiment 2 of the present invention, preamble PA of servo data to be reproduced is decoded as serial clock SC, and synchronous serial communication is performed using serial clock SC. Thus, oscillators (OSC) 10 and 35 required in embodiment 1 are not required in embodiment 2. As discussed in embodiment 1, in a circuit where the oscillator always generates a clock asynchronously to the read data, even little noise generated by the clock disturbs the read data. In this case, even a circuit employing a logic cell for IC driven at low power supply voltage causes the same problem.

Especially in reproducing user data, the disturbance cannot be neglected, because the user data includes a high-frequency signal of which level is extremely reduced. In embodiment 2, serial clock SC is generated from a simple analog filter and a comparator. Serial clock SC is also generated based on preamble data of servo data having high signal/noise ratio (S/N) as signal quality, and communications are performed only in the generation time. Therefore, the influence of disturbance caused by high-frequency noise generated by clock and data in the communications is also relatively reduced. Thus, in embodiment 2, the disturbance to the reproduced signal caused by the communications can be further reduced comparing with embodiment 1. Therefore, a disk device capable of obtaining a sufficient read signal while setting and reading a register of the head IC can be provided.

In embodiment 2, reduction of the influence of the disturbance caused by communications on the read signal receives attention, so that communications performed when the disk device does not lie in the read state are not shown. However, communications cannot be performed when the disk device does not lie in the read state, because serial clock SC is generated from data of preamble PA of servo data. However, communications can be easily performed when read amplifier 3 has an oscillating circuit for generating a reproduced signal of artificial preamble PA. Alternatively, communications of embodiment 2 may be performed only when the read amplifier lies in the read state, or serial communications using three lines similarly to the conventional art may be performed when the read amplifier does not lie in the read state.

The configuration of the present embodiment does not require three signal lines for serial communications that are required in the conventional art. The number of pins of FPC 21 for coupling head IC 1 to the digital control circuit side can be reduced. Additionally, the signal level used for communications can be decreased from the above-mentioned TTL level or CMOS level to several hundreds mV corresponding to the level of the read/write signal. Thus, the cross talk component during communications can be reduced by 15 dB or more. Since paired wiring of the differential two-wire type is employed, noise of a high-frequency component occurring during communications is reduced by capacity coupling between differentials, and influence on the power supply ground can be reduced.

Recently, a disk device has been increasingly applied to a mobile device, and microminiaturization of the disk device has been demanded. As the disk device is miniaturized, the degree of integration of the circuit board needs to be increased and distance between lines needs to be decreased. The cross talk between lines and a large number of lines between circuit blocks therefore significantly disturb the miniaturization. In the present invention, while various sensor amplifiers are integrated into the head IC, the cross talk to a read signal closely related to the device performance can be significantly reduced, the number of connector lines for electrically coupling the inside of the device case to the circuit board can be simultaneously reduced. Thus, the disk device can be remarkably miniaturized.

### INDUSTRIAL APPLICABILITY

In the configuration of the present invention, in communications for setting and reading a register of a head IC into which a read/write preamplifier circuit and various sensor amplifiers are integrated, a differential input line of the write signal is used as the communication line during reading, and a differential output line of the read signal is used as the communication line during writing. When the signal level used for the communications is set at the same level as the level of the write input signal or the level of the read output signal, the signal noise in the communications can be reduced.

Thus, a reproduced signal can be sufficiently obtained while the communications with the head IC are always kept. By eliminating a conventionally required communication line, the mounting area of a connector on the circuit board to be mounted to the case of the disk device can be reduced, and the disk device can be microminiaturized. The industrial applicability is high.

1. A disk device comprising:
an FPC through which an actuator is electrically coupled to a device control circuit, the actuator moving read and write heads in a direction crossing a track of a disk medium, the device control circuit being mounted on a device case; and
a head IC on which a read/write preamplifier circuit and one or more sensor amplifiers are integrated, the head IC being mounted on the FPC,
wherein,
an operation of the IC is determined according to a value of a register integrated in the head IC,
a value detected by the amplifier is also stored in the register, and
as a communication line required to make the device control circuit sets and reads a value from the register, one or both of a read signal output line and a write signal input line of the read/write preamplifier circuit are used.

2. The disk device of claim 1, wherein,
one of the read signal output line and the write signal input line also used as the communication line is of a paired two-wire type employing a differential signal.

3. The disk device of claim 1, wherein,
communications are performed while signal level of one of the read signal output line and the write signal input line also used as the communication line is equal to a signal level of one of a read signal and a write signal.

4. The disk device of claim 1, wherein,
both the head IC and the device control circuit have an oscillator oscillating at an identical frequency, and
communications are performed in an asynchronous communication method where a rate of a sampling clock obtained by dividing oscillating frequency of the oscillator into a predetermined number is used as a bow rate.

5. The disk device of claim 1, wherein,
both the head IC and the device control circuit have a serial clock generating circuit for generating a serial clock from a preamble signal of servo data reproduced by the head IC, and
communications are performed in a synchronous communication method based on the serial clock.
